(19) United States
(12) Patent Application Publication
(10) Pub. No.: US 2023/0311075 A1
(43) Pub. Date: Oct. 5, 2023

(54) Membrane Electrode Assembly with a Selectively Permeable Barrier Layer

(71) Applicant: Kraton Corporation, Houston, TX (US)

(72) Inventors: Roger Tocchetto, Houston, TX (US); Lee Barnes, Houston, TX (US)

(73) Assignee: Kraton Corporation, Houston, TX (US)

(21) Appl. No.: 18/191,042

(22) Filed: Mar. 28, 2023

Related U.S. Application Data
(60) Provisional application No. 63/362,080, filed on Mar. 29, 2022.

(51) Int. Cl. B01D 71/80; B01D 69/02; B01D 71/28; B01D 71/26; B01D 53/32; B01D 53/26; C25B 13/08; C25B 9/23; H01M 8/1004; H01M 8/1023; H01M 8/1067

(52) U.S. Cl. CPC B01D 71/80; B01D 69/02; B01D 71/281; B01D 71/261; B01D 71/262; B01D 53/326; B01D 53/268; C25B 13/08; C25B 9/23; H01M 8/1004; H01M 8/1023; H01M 8/1067; B01D 2325/10; B01D 2325/14; B01D 2325/20; B01D 2325/42; B01D 2255/806; B01D 2257/80; B01D 2257/504; C25B 1/16

(57) ABSTRACT

An electrochemical cell comprising a membrane electrode assembly and a selectively permeable barrier layer comprising sulfonated polymer is disclosed. The selectively permeable barrier layer is arranged facing at least one electrocatalyst layer, e.g., anode or cathode. The sulfonated polymer layer aids in controlling the movement of fluids and/or their constituents into and out of the electrochemical cell assembly for separation or capture for subsequent use.

### RELATED APPLICATIONS

This application claims benefit to U.S. Provisional Application No. 63/362,080, filed on Mar. 29, 2022, which is hereby incorporated herein by reference.

### TECHNICAL FIELD

The disclosure relates to an electrochemical cell assembly comprising a membrane electrode assembly and a selectively permeable barrier layer to facilitate separation of certain fluid(s) from a mixture of fluids.

### BACKGROUND

Membrane electrode assembly (“MEA”) are used in many applications, e.g., electrolyzers, polymer electrolyte fuel cells, hydrogen/oxygen air fuel cells, direct methanol fuel cells, fluid separation, etc. The principal function of the MEA is to efficiently control the flow of electrons liberated at the electron donating reaction (anode) to the electron accepting reaction (cathode). This is typically achieved by separating the cathodic reaction from the anodic reaction by using a membrane that conducts protons, e.g., H⁺, only.

A typical five-layer MEA is composed of a proton exchange membrane (“PEM”) or anion exchange membrane (“AEM”), two catalyst layers, and optionally gas diffusion layers, supporting frame and other application specific components. MEAs can function with the application of a voltage between the anode and cathode, usually with the use of a power supply, but can operate as a passive MEA without a power supply. An alternative version of a five-layer MEA is a three-layer MEA which is composed of a PEM or AEM with the catalyst layers applied to both sides of the anode and cathode.

In hydrolysis reactions, MEAs are used to control the flow and direction of electrons, H₂O can either be used to produce H₂ and O₂ (hydrolysis) or can be produced from H₂ and O₂ (fuel cell). In addition to hydrolysis, MEAs can be used to electrochemically oxidize other compounds, e.g., carbon dioxide, methanol, ethanol, formaldehyde, formic acid, sodium chloride, etc. MEAs can also be used to electrochemically synthesize compounds, e.g., ammonia, methane, hydrogen peroxide, etc.

In the prior art MEAs, fluid/ion separated in the MEA can flow back into the feed stream or other originating source, e.g., enclosure, increasing the amount of a fluid/ion in the space which can be undesirable. In some instances, there can be cross-over contamination, as in methanol fuel cells, across the anode and cathode.

Therefore, there is a need for an electrochemical cell assembly comprising an MEA and a selectively permeable barrier layer which aids in selectively retaining or controlling the movement of fluids, molecules, ions, etc.

### SUMMARY

In one aspect, an electrochemical cell assembly is disclosed. The electrochemical cell assembly comprises a membrane electrode assembly to break apart a fluid containing at least a first component and a second component to at least two constituents, a first constituent and a second constituent, and a barrier layer. The membrane electrode assembly comprises a first electrocatalyst layer, a second electrocatalyst layer, and an ion exchange membrane arranged between the first and second electrocatalyst layers. The barrier layer is external to the membrane electrode assembly, spaced apart and facing the first or second electrocatalyst layer of the membrane electrode assembly. The barrier layer comprising a sulfonated polymer membrane, wherein the sulfonated polymer is selected from the group consisting essentially of sulfonated block copolymers, perfluorosulfonic acid polymers, polystyrene sulfonates, sulfonated polyolefins, sulfonated polyimides, sulfonated polyamides, sulfonated polyesters, sulfonated polysulfones, sulfonated polyketones, sulfonated poly(arylene ether), and mixtures thereof, the sulfonated polymer has an ionic exchange capacity (IEC) of at least 0.5 meq/g. The barrier layer is supported by a spacer layer or a frame for separating the barrier layer from the first or second electrocatalyst layer. The barrier layer is selectively permeable to the first and second component and the first and second constituents, the barrier layer having at least one of: a permeability ratio of the first component to the second component of >5:1, a permeability ratio of the first constituent and the second constituent of >5:1, and a permeability ratio of the first or second component to the first or second constituent of >5:1, thereby restricting the flow of at least one of the components and the constituents.

In one aspect, an electrochemical cell assembly is disclosed. The electrochemical cell assembly comprises a membrane electrode assembly to break apart a fluid containing at least a first component and a second component to at least two constituents, a first constituent and a second constituent, and a first and second barrier layer. The membrane electrode assembly comprises a first electrocatalyst layer, a second electrocatalyst layer, and an ion exchange membrane arranged between the first and second electrocatalyst layers. The first barrier layer and second barrier layer are external to the membrane electrode assembly, spaced apart and facing the first or second electrocatalyst layer of the membrane electrode assembly. The barrier layer comprising a sulfonated polymer membrane, wherein the sulfonated polymer is selected from the group consisting essentially of sulfonated block copolymers, perfluorosulfonic acid polymers, polystyrene sulfonates, sulfonated polyolefins, sulfonated polyimides, sulfonated polyamides, sulfonated polyesters, sulfonated polysulfones, sulfonated polyketones, sulfonated poly(arylene ether), and mixtures thereof, the sulfonated polymer has an ionic exchange capacity (IEC) of at least 0.5 meq/g. The barrier layer is supported by a spacer layer or a frame for separating the barrier layer from the first or second electrocatalyst layer. The barrier layer is selectively permeable to the first and second component and the first and second constituents, the barrier layer having at least one of: a permeability ratio of the first component to the second component of >5:1, a permeability ratio of the first constituent and the second constituent of >5:1, and a permeability ratio of the first or second component to the first or second constituent of >5:1, thereby restricting the flow of at least one of the components and the constituents.

A fluid separation assembly, comprising an enclosure and an electrochemical cell assembly arranged in fluid communication with the enclosure and adapted to receive or provide a fluid to the enclosure. The electrochemical cell assembly comprises a membrane electrode assembly to break apart a fluid containing at least a first component and a second component to at least two constituents, a first constituent and a second constituent, and a barrier layer. The membrane electrode assembly comprises a first electrocatalyst layer, a second electrocatalyst layer, and an ion exchange membrane arranged between the first and second electrocatalyst layers. The barrier layer is external to the membrane electrode assembly, spaced apart and facing the first or second electrocatalyst layer of the membrane electrode assembly. The barrier layer comprising a sulfonated polymer membrane, wherein the sulfonated polymer is selected from the group consisting essentially of sulfonated block copolymers, perfluorosulfonic acid polymers, polystyrene sulfonates, sulfonated polyolefins, sulfonated polyimides, sulfonated polyamides, sulfonated polyesters, sulfonated polysulfones, sulfonated polyketones, sulfonated poly(arylene ether), and mixtures thereof, the sulfonated polymer has an ionic exchange capacity (IEC) of >0.5 meq/g. The barrier layer is supported by a spacer layer or a frame for separating the barrier layer from the first or second electrocatalyst layer. The barrier layer is selectively permeable to the first and second component and the first and second constituents, the barrier layer having at least one of: a permeability ratio of the first component to the second component of >5:1, a permeability ratio of the first constituent and the second constituent of >5:1, and a permeability ratio of the first or second component to the first or second constituent of >5:1, thereby restricting the flow of at least one of the components and the constituents.

### DESCRIPTION OF THE DRAWINGS

FIG. 1 illustrates schematic view of a membrane electrode assembly having an ion exchange membrane as a proton exchange membrane and a barrier layer as proton exchange membrane.

FIG. 2 illustrates a schematic view of a membrane electrode assembly having an ion exchange membrane as a proton exchange membrane and two barrier layers.

FIG. 3 illustrates a schematic view of a membrane electrode assembly having an ion exchange membrane as an anion exchange membrane and a barrier layer as proton exchange membrane.

FIG. 4 illustrates a schematic view of a membrane electrode assembly having an ion exchange membrane as an anion exchange membrane and two barrier layers.

FIG. 5 is a schematic view of an enclosure assembly having the membrane electrode assembly of FIG. 1.

FIG. 6 is a schematic view of an enclosure assembly having the membrane electrode assembly of FIG. 1.

FIG. 7 is a schematic view of an enclosure assembly having the membrane electrode assembly of FIG. 3.

### DETAILED DESCRIPTION

The following terms used the specification have the following meanings:

“At least one of [a group such as A, B, and C]” or “any of [a group such as A, B, and C]” means a single member from the group, more than one member from the group, or a combination of members from the group. For example, at least one of A, B, and C includes, for example, A only, B only, or C only, as well as A and B, A and C, B and C; or A, B, and C, or any other all combinations of A, B, and C.

“Selected from X1, X2, X3, . . . , Xn, and mixtures thereof” means a single member of the group or more than a member of the group, e.g., X1, X2, X3, . . . Xn, or some, or all members of the group X1-Xn being present.

A list of embodiments presented as “A, B, or C” is to be interpreted as including the embodiments: A only, B only, C only, “A or B,” “A or C,” “B or C,” or “A, B, or C.”

“Molecular weight” or “MW” refers to styrene equivalent molecular weight in g/mol (unless otherwise indicated) of a polymer block or a block copolymer. MW can be measured with gel permeation chromatography (GPC) using polystyrene calibration standards, such as is done according to ASTM 5296-19. The GPC detector can be an ultraviolet or refractive index detector or a combination. The chromatograph is calibrated using commercially available polystyrene molecular weight standards. MW of polymers measured using GPC so calibrated are styrene equivalent molecular weights or apparent molecular weights. MW expressed herein is measured at the peak of the GPC trace- and commonly referred to as styrene equivalent “peak molecular weights,” designated as Mₚ.

“Ion exchange membrane” or “IEM” refers to a semi-permeable membrane that transports certain dissolved ions, while blocking other ions or certain neutral molecules. Ion exchange membranes are therefore electrically conductive, moving ions from one electrode to another electrode during an electrolysis process. Examples of ion-exchange membranes include proton-exchange membranes that transport H⁺ cations, and anion exchange membranes that transport OH⁻ anions.

“Enclosure” refers to a confined space, such as a box, a container containing components including fluid to be separated, recovered, or collected, with openings for inlet and outlet streams from/to an electrochemical cell. Exemplary enclosures include humidors, wine cellars, etc.

“Fluid” or “fluids” is a liquid, gas or other material that can deform under applied stress or external force.

“Barrier layer” means a layer or a structure that is selectively permeable to certain fluid(s), molecule(s), or ion(s), while blocking the passage of other fluid(s), molecule(s), and/or ion(s).

“Permeability” means an ability of a material to transmit fluids, molecules, and/or ions through it.

“Selective permeability” means an ability of a material to transmit certain fluids, molecules, and/or ions through it, while blocking/inhibiting/limiting passage of others.

“Impermeability” (and the adjective equivalent “impermeable”) refers to the ability of a material to restrict/block/limit a passage of fluid(s) or constituents (ions, molecules, etc.) through it, or allowing very small relative amount, <0.5%, <0.1%, or <0.05%, or <0.01%, or <0.001%, or practically none to flow through.

“Permeability ratio” is the ratio comparing the permeability of a material to two different fluids(s), molecule(s), and/or ion(s), e.g., permeability ratio of a barrier layer to two fluids, one that is permeable and a second one that is not permeable or impermeable.

“Electrocatalyst layer” is a layer that functions as an electrically conductive element and can be made of metal, such as copper, aluminum, zinc, titanium, platinum, gold, iridium, silver, nickel, brass, iron, and other metals, or any other electrically conducting element, and acts as an electrode, i.e., an anode or a cathode, during an electrolytic reaction, when the electrocatalyst layer is connected to a terminal of a power source, e.g., a battery. The electrocatalyst layer can be a metal itself or can be an electrically conductive material coated with a catalyst. The electrocatalyst layer can include a gas diffusion layers.

“Gas diffusion layers” or “GDL” are layers to promote a uniform distribution of reactive fluids, molecules, and/or ions on the surface of the electrode, and the transport of electrons to or from the external electrical circuit. GDL may also be used in the electrode assembly as a scaffolding material for catalyst impregnation, depending on the MEA assembly technique. In embodiments, the gas diffusion layer is a porous layer made by weaving carbon fibers into a carbon cloth or by pressing carbon fibers together into a carbon paper, or may be formed of porous, electrically conductive materials such as carbon fiber paper, carbon fiber woven fabric, carbon fiber fabrics, metal or metal alloy screen, metal or metal alloy nets, metalized fiber fabrics and the like.

“Anode” is an electrode at which oxidation reaction occurs and has positive charge. Accordingly, negatively charged ions moves towards the anode during electrolysis reaction.

“Cathode” is an electrode at which a reduction reaction occurs and has a negative charge. Accordingly, positively charged ions move towards the cathode during an electrolysis reaction.

“Constituent(s)” refer to the protons, electrons, or molecules of the fluid as processed/separated in the MEA. For example, in the MEA, water is broken down into the constituents H₂ and O₂.

“Ion Exchange Capacity” or IEC refers to the total active sites or functional groups responsible for ion exchange in a polymer. A conventional acid-base titration method can be used to determine the IEC, e.g., International Journal of Hydrogen Energy, Volume 39, Issue 10, Mar. 26, 2014, Pages 5054-5062, “Determination of the ion exchange capacity of anion-selective membrane.” IEC is the inverse of “equivalent weight” or EW, which the weight of the polymer required to provide 1 mole of exchangeable protons.

The disclosure relates to an electrochemical cell assembly comprising a membrane electrode assembly and a selectively permeable sulfonated polymer barrier layer. The sulfonated polymer barrier layer is arranged facing at least one of the electrocatalyst layers of the membrane electrode assembly. The sulfonated polymer barrier layer aids in controlling the movement of fluids, molecules, and/or ions into and out of the MEA for separation or capture for subsequent use.

Selectively Permeable Barrier Layer: The electrochemical cell assembly comprises a barrier layer comprising, or consisting essentially of, or consisting of a sulfonated polymer as described below. The barrier layer is arranged facing at least one of the electrocatalyst layers of the membrane electrode assembly such that the electrocatalyst layer is arranged between the ion exchange membrane, defining a gap between the barrier layer and the electrocatalyst layer.

In embodiments, the barrier layer is selectively permeable to a feed stream of a fluid containing a least a first component and a second component allowing one of the first and second component to pass through to the gap and to the first electrocatalyst layer.

In embodiments, the barrier layer allows certain fluid(s) to pass through to the gap and to the first electrocatalyst layer, where the fluid is reduced/separated into constituents, e.g., first constituent and second constituent. In embodiments, the barrier layer is impermeable to at least one of the first and second constituents of the fluid to prevent flow back into the feed or enclosure. The constituents can escape through the gap or be captured for storage.

In another embodiment, the barrier layer is adjacent to the second electrocatalyst layer allowing permeable fluid and/or constituents to pass though, while trapping fluid and/or constituents that are impermeable to the barrier layer for subsequent capture or release.

In embodiments, the barrier layer is selectively permeable with respect to the components in the feed stream or its constituents, having a permeability ratio of first component to the second component (or first constituent to second constituent) of >1500:1, or >1000:1, or >500:1, or >250:1, or >100:1, or >20:1, or >15:1, or >10:1, or >5:1, and correspondingly allowing more flow of the first component to the second component (or first constituent to second constituent) for a ratio of >1500:1, or >1000:1, or >500:1, or >250:1, or >100:1, or >20:1, or >15:1, or >10:1, or >5:1.

In embodiments, where the electrochemical cell assembly comprises only one barrier layer, the barrier layer comprises, or consisting essentially of, or consists of a sulfonated polymer, e.g., a sulfonated block copolymer. In embodiments, where the electrochemical cell assembly comprises more than one barrier layer, at least one of the barrier layers comprises, or consisting essentially of, or consists of a sulfonated polymer. The barrier layer can be positioned on either side of the MEA (at the first electrocatalyst layer or the second electrocatalyst layer) depending on the selectivity and permeability of the barrier and desired separation and/or application of the electrochemical cell assembly.

In embodiments, the sulfonated polymer is a film formed by preparing a solution of the sulfonated polymer in a suitable solvent, then casting the sulfonated polymer solution forming the film. In embodiments, the sulfonated polymer is casted directly on a spacer material.

The sulfonated polymer film can be bonded or incorporated onto a frame. The sulfonated polymer film can be held in place around the edges of the frame with adhesive, screws, or other mechanical means. The frame can be thermally or mechanically formed and is preferably rigid, semi-rigid, or substantially rigid. As used herein, a rigid, semi-rigid or substantially rigid frame is a frame comprising a material or structure able to maintain its shape under its own weight. Suitable frame materials include fiberglass, aluminum, carbon, or a rigid polymer based on polyester, polyethylene, polypropylene, polyethylene terephthalate, polyvinylchloride, a styrene/acrylonitrile/butadiene copolymer, nylon, polytetrafluoroethylene, aramid-based polymeric fibers, metal, metal alloys, cellulose, cellulose nitrate, cellulose acetate, and combinations thereof.

In embodiments, the barrier comprises a composite layer containing the sulfonated polymer and a woven or non-woven porous spacer material. Examples of porous spacer materials include linen fiber, acrylic fiber, vinylon, carbon fiber, glass fiber, aramid fiber, polyethylene (PE) fiber, polypropylene (PP) fiber, polyethylene terephthalate (PET) fiber, polybutylene terephthalate (PBT) fiber, polyarylate fiber, polyvinyl alcohol fiber, benzazole fiber, poly(para-phenylene) benzobisoxazole fiber, olyphenylene sulfide (PPS) fiber, polytetrafluoroethylene (PTFE) fiber, mixtures thereof. In embodiments, the porous spacer material is a microporous polyethylene film thermally bonded to a polyethylene/PET bicomponent nonwoven.

The composite layer can be formed by applying sulfonated polymer onto the porous spacer material by preparing a solution of the sulfonated polymer in a suitable solvent, then casting the sulfonated polymer solution on the porous spacer material, with the thickness of the film being adjusted with a casting knife, followed by drying. In embodiments, the sulfonated polymer is coated on the porous spacer material by methods, including but not limited to, slot die coating, knife-over-roll coating, microgravure coating, spray coating, or dip coating the sulfonated polymer over the porous spacer material. Multiple coatings can be applied sequentially.

In embodiments, when the sulfonated polymer is cast into a film, the film thickness is 0.005-200 μm, or 0.005-100 μm, or 0.005-50 μm, or 0.005-25 μm, or 0.005-20 μm, or 0.01-15 μm, 0.01-10 μm, or >0.001 μm, or >0.005 μm, or <200 μm, or <100 μm, or <50 μm, or <40 μm, or <30 μm, or <25 μm.

In embodiments, the sulfonated polymer is coated on the spacer material at a thickness of 0.005-200 μm, or 0.005-100 μm, or 0.005-50 μm, or 0.005-25 μm, or 0.005-20 μm, or 0.01-15 μm, 0.01-10 μm, or >0.001 μm, or >0.005 μm, or <200 μm, or <100 μm, or <50 μm, or <40 μm, or <30 μm, or <25 μm.

In embodiments, the porous spacer material or frame separates the sulfonated polymer of the barrier layer from adjacent electrocatalyst layer(s) by a spacing of at least 0.3 nm, or >0.5 nm, or >1 nm, or <150 μm, or <125, or <115 μm.

Sulfonated Polymer: The barrier layer comprises, consists essentially of, or consists of a sulfonated polymer. Sulfonated polymer refers to polymers having a sulfonate group, e.g., —SO₃, either in the acid form (e.g., —SO₃H, sulfonic acid) or a salt form (e.g., —SO₃Na). The term “sulfonated polymer” also covers sulfonate containing polymers, e.g., polystyrene sulfonate.

The sulfonated polymer is selected from the group of sulfonated block copolymers, perfluorosulfonic acid polymers (e.g., sulfonated tetrafluoroethylene), sulfonated polyolefins, sulfonated polyimides, sulfonated polyamides, sulfonated polyester, polystyrene sulfonates, sulfonated polyolefins, sulfonated polysulfones such as polyether sulfone, sulfonated polyketones such as polyether ether ketone, sulfonated polyphenylene ethers, and mixtures thereof.

The sulfonated polymer is characterized as being sufficiently or selectively sulfonated to contain from 10-100 mol % sulfonic acid or sulfonate salt functional groups based on the number of monomer units or the block to be sulfonated (“degree of sulfonation”). In embodiments, the sulfonated polymer has a degree of sulfonation of at least 10 mol %, or >15, or >20, or >25, or >30, or >40, or >50, or >60, or >70, or >80, or >90, or >99, or 10-100, or 20-90, or 30-80 mol %. The degree of sulfonation can be calculated by NMR or ion exchange capacity (IEC). In embodiments, the sulfonated polymer has an ion exchange capacity (IEC) of at least 0.5, or >0.75, or >1.0, or >1.5, or >2.0, or >2.5, or <5.0 or 0.5-3.5, 0.75-3.0, or 0.5-2.6 meq/g.

In embodiments, the sulfonated polymer is a sulfonated tetrafluoroethylene, having a polytetrafluoroethylene (PTFE) backbone; (2) side chains of vinyl ethers (e.g., —O—CF₂—CF—O—CF₂—CF₂—) which terminate in sulfonic acid groups in a cluster region.

In embodiments, the sulfonated polymer is a polystyrene sulfonate, examples include potassium polystyrene sulfonate, sodium polystyrene sulfonate, a co-polymer of sodium polystyrene sulfonate and potassium polystyrene sulfonate (e.g., a polystyrene sulfonate copolymer), having a molecular weight of 20,000 to 1,000,000 Daltons, or >25,000 Daltons, or >40,000 Dalton, or >50,000, or >75,000, or >100,000 Daltons, or >400,000 Daltons, or <200,000, or <800,000 Daltons, or up to 1,500,000 Daltons. The polystyrene sulfonate polymers can either be crosslinked or uncrosslinked. In embodiments, the polystyrene sulfonate polymers are uncrosslinked and water soluble.

In embodiments, the sulfonated polymer is a polysulfone, selected from the group of aromatic polysulfones, polyphenylenesulfones, aromatic polyether sulfones, dichlorodiphenoxy sulfones, sulfonated substituted polysulfone polymers, and mixtures thereof. In embodiments, the sulfonated polymer is a sulfonated polyethersulfone copolymer, which can be made with reactants including sulfonate salts such as hydroquinone 2-potassium sulfonate (HPS) with other monomers, e.g., bisphenol A and 4-fluorophenyl sulfone. The degree of sulfonation in the polymer can be controlled with the amount of HPS unit in the polymer backbone.

In embodiments, the sulfonated polymer is a sulfonated polyether ketone. In embodiments, the sulfonated polymer is a sulfonated polyether ketone ketone (SPEKK), obtained by sulfonating a polyether ketone ketone (PEKK). The polyether ketone ketone can be manufactured using diphenyl ether and a benzene dicarbonic acid derivative. The sulfonated PEKK can be available as an alcohol and/or water-soluble product, e.g., for subsequent use to coat the substrate or in spray applications.

In embodiments, the sulfonated polymer is a sulfonated poly(arylene ether) copolymer containing pendant sulfonic acid groups. In embodiments, the sulfonated polymer is a sulfonated poly(2,6-dimethyl-1,4-phenylene oxide), commonly referred to as sulfonated polyphenylene oxide. In embodiments, the sulfonated polymer is a sulfonated poly(4-phenoxybenzoyl-1,4-phenylene) (S-PPBP). In embodiments, the sulfonated polymer is a sulfonated polyphenylene having 2 to 6 pendant sulfonic acid groups per polymer repeat and characterized as having 0.5 meq (SO₃H)/g of polymer to 5.0 meq (SO₃H)/g polymer, or at least 6 meq/g (SO₃H)/g polymer.

In embodiments, the sulfonated polymer is a sulfonated polyamide, e.g., aliphatic polyamides such nylon-6 and nylon-6,6, partially aromatic polyamides and polyarylamides such as poly(phenyldiamidoterephthalate), provided with sulfonate groups chemically bonded as amine pendant groups to nitrogen atoms in the polymer backbone. The sulfonated polyamide can have a sulfonation level of 20 to up to 100% of the amide group, with the sulfonation throughout the bulk of the polyamide. In embodiments, the sulfonation is limited to a high density of sulfonate groups at the surface, e.g., >10%, >20%, >30%, or >40%, or up to 100% of the sulfonated amide group at the surface (within 50 nm of the surface).

In embodiments, the sulfonated polymer is a sulfonated polyolefin, containing at least 0.1 meq, or >2 meq, or >3 meq, or >5 meq, or 0.1 to 6 meq of sulfonic acid per gram of polyolefin. In embodiments, the sulfonated polymer is a sulfonated polyethylene. The sulfonated polyolefin can be formed by chlorosulfonation of a solid polyolefin obtained by polymerization of an olefin, or a mixture of olefins selected from a group consisting of ethylene, propylene, butene-1,4-methylpentene-1, isobutylene, and styrene. The sulfonyl chloride groups can then be hydrolyzed, for example, in an aqueous base such as potassium hydroxide or in a water dimethylsulfoxide (DMF) mixture to form sulfonic acid groups. In embodiment, the sulfonated polyolefin is formed by submerging or passing polyolefin object in any form of powder, fiber, yarn, woven fabric, a film, a preform, etc., through a liquid containing sulfur trioxide (SO₃), a sulfur trioxide precursor (e.g., chlorosulfonic acid, HSO₃Cl), sulfur dioxide (SO₂), or a mixture thereof. In other embodiments, the polyolefin object is brought into contact with a sulfonating gas, e.g., SO₂or SO₃, or gaseous reactive precursor, or a sulfonation additive that evolves a gas SOₓ (x=1-4) at elevated temperature.

The polyolefin precursor to be sulfonated can be, for example, a poly-α-olefin, such as polyethylene, polypropylene, polybutylene, polyisobutylene, ethylene propylene rubber, or a chlorinated polyolefin (e.g., polyvinylchloride, or PVC), or a polydiene, such as polybutadiene (e.g., poly-1,3-butadiene or poly-1,2-butadiene), polyisoprene, dicyclopentadiene, ethylidene norbornene, or vinyl norbornene, or a homogeneous or heterogeneous composite thereof, or a copolymer thereof (e.g., EPDM rubber, i.e., ethylene propylene diene monomer). In embodiments, the polyolefin is selected from low density polyethylene (LDPE), linear low-density polyethylene (LLDPE), very low-density polyethylene (VLDPE), high density polyethylene (HDPE), medium density polyethylene (MDPE), high molecular weight polyethylene (HMWPE), and ultra-high molecular weight polyethylene (UHMWPE).

In embodiments, the sulfonated polymer is a sulfonated polyimide, e.g., aromatic polyimides in both thermoplastic and thermosetting forms, having excellent chemical stability and high modulus properties. Sulfonated polyimide can be prepared by condensation polymerization of dianhydrides with diamines, wherein one of the monomeric units contains sulfonic acid, sulfonic acid salt, or sulfonic ester group. The polymer can also be prepared by direct sulfonation of aromatic polyimide precursors, using sulfonation agents such as chlorosulfonic acid, sulfur trioxide and sulfur trioxide complexes.

In embodiments, the sulfonated polymer is a sulfonated polyester, formed by directly sulfonating a polyester resin in any form, e.g., fiber, yarn, woven fabric, film, sheet, and the like, with a sulfuric anhydride-containing gas containing sulfuric anhydride.

In embodiments, the sulfonated polymer is a selectively sulfonated negative-charged anionic block copolymer. The term “selectively sulfonated” definition to include sulfonic acid as well as neutralized sulfonate derivatives. The sulfonate group can be in the form of metal salt, ammonium salt or amine salt.

Depending on the applications and the desired properties, the sulfonated polymer can be modified (or functionalized) or complexed with other materials. In embodiments, the sulfonated polymer is neutralized with any of various metal counterions, including alkali, alkaline earth, and transition metals, with at least 10% of the sulfonic acid groups being neutralized. In embodiments, the sulfonated polymer is neutralized with inorganic or organic cationic salts, e.g., those based on lithium, ammonium, phosphonium, pyridinium, sulfonium and the like. Salts can be monomeric, oligomeric, or polymeric. In embodiments, the sulfonated polymer is neutralized with various primary, secondary, or tertiary amine-containing molecules, with >10% of the sulfonic acid or sulfonate functional groups being neutralized.

In one embodiment, the permeability of the sulfonated block copolymer is tailored by complexing with metal ions, e.g., Na⁺, K⁺, and Ca²⁺, for ultrahigh permeability, e.g., NH₃ permeability exceeding 5000 Barrers, as disclosed in L. Ansaloni et al., “Solvent-templated block ionomers for base- and acid-gas separations: effect of humidity on ammonia and carbon dioxide permeation,” Adv. Mater. Interf. 4 (2017), incorporated herein by reference. In embodiments, the sulfonated block copolymer is modified by incorporating ionic liquid so that the sulfonated block copolymer has high CO₂ solubility and CO₂ selectivity over other gases, as disclosed in Zhongde Dai, et al., “Incorporation of an ionic liquid into a midblock-sulfonated multiblock polymer for CO2 capture,” Journal of Membrane Science, June 2019, incorporated herein by reference.

In embodiments, the sulfonic acid or sulfonate functional group is modified by reaction with an effective amount of polyoxyalkyleneamine having molecular weights from 140 to 10,000. Amine-containing neutralizing agents can be mono-functional or multi-functional; monomeric, oligomeric, or polymeric. In alternative embodiments, the sulfonated polymer is modified with alternative anionic functionalities, such as phosphonic acid or acrylic and alkyl acrylic acids.

In embodiments, amine containing polymers are used for the modification of the sulfonated polymers, forming members of a class of materials termed coaservates. In examples, the neutralizing agent is a polymeric amine, e.g., polymers containing benzylamine functionality. Examples include homopolymers and copolymers of 4-dimethylaminostyrene which has been described in U.S. Pat. No. 9,849,450, incorporated herein by reference. In embodiments, the neutralizing agents are selected from polymers containing vinylbenzylamine functionality, e.g., polymers synthesized from poly-p-methylstyrene containing block copolymers via a bromination-amination strategy, or by direct anionic polymerization of amine containing styrenic monomers. Examples of amine functionalities for functionalization include but are not limited to p-vinylbenzyldimethylamine (BDMA), p-vinylbenzylpyrrolidine (VBPyr), p-vinylbenzyl-bis(2-methoxyethyl)amine (VBDEM), p-vinylbenzylpiperazine (VBMPip), and p-vinylbenzyldiphenylamine (VBDPA). In embodiments, corresponding phosphorus containing polymers can also be used for the functionalization of the sulfonated polymers.

In embodiments, the monomer or the block containing amine functionality or phosphine functionality can be neutralized with acids or proton donors, creating quaternary ammonium or phosphonium salts. In other embodiments, the sulfonated polymer containing tertiary amine is reacted with alkylhalides to form functional groups, e.g., quaternized salts. In some embodiments, the sulfonated polymer can contain both cationic and anionic functionality to form so-called zwitterionic polymers.

In embodiments, the sulfonated polymer is a selectively sulfonated negative-charged anionic block copolymer, wherein “selectively sulfonated” includes sulfonic acid as well as neutralized sulfonate derivatives. The sulfonate group can be in the form of metal salt, ammonium salt or amine salt. In embodiments, the sulfonated polymer is a sulfonated styrenic block copolymer obtained by sulfonation of a styrenic block copolymer precursor having a general configuration of A-B-A, (A-B)ₙ(A), (A-B-A)ₙ, (A-B-A)ₙX, (A-B)ₙX, A-D-B, A-B-D, A-D-B-D-A, A-B-D-B-A, (A-D-B)ₙA, (A-B-D)ₙA (A-D-B)ₙX, (A-B-D)ₙX or mixtures thereof; where n is an integer from 0 to 30, or 2 to 20 in embodiments; and X is a coupling agent residue. Each A and D block is a polymer block resistant to sulfonation. Each B block is susceptible to sulfonation. For configurations with multiple A, B or D blocks, the plurality of A blocks, B blocks, or D blocks can be the same or different.

In embodiments, the A blocks are one or more segments selected from polymerized (i) para-substituted styrene monomers, (ii) ethylene, (iii) alpha olefins of 3 to 18 carbon atoms; (iv) 1,3-cyclodiene monomers, (v) monomers of conjugated dienes having a vinyl content less than 35 mol percent prior to hydrogenation, (vi) acrylic esters, (vii) methacrylic esters, and (viii) mixtures thereof. If the A segments are polymers of 1,3-cyclodiene or conjugated dienes, the segments will be hydrogenated subsequent to polymerization of the block copolymer and before sulfonation of the block copolymer. The A blocks may also contain up to 15 mol % of the vinyl aromatic monomers such as those present in the B blocks.

In embodiments, the A block is selected from para-substituted styrene monomers selected from para-methylstyrene, para-ethylstyrene, para-n-propylstyrene, para-iso-propylstyrene, para-n-butylstyrene, para-sec-butylstyrene, para-iso-butylstyrene, para-t-butylstyrene, isomers of para-decylstyrene, isomers of para-dodecylstyrene and mixtures of the above monomers. Examples of para-substituted styrene monomers include para-t-butylstyrene and para-methylstyrene, with para-t-butylstyrene being most preferred. Monomers may be mixtures of monomers, depending on the particular source. In embodiments, the overall purity of the para-substituted styrene monomers is at least 90%, or >95%, or >98%.

In embodiments, the block B comprises segments of one or more polymerized vinyl aromatic monomers selected from unsubstituted styrene monomer, ortho-substituted styrene monomers, meta-substituted styrene monomers, alpha-methylstyrene monomer, 1,1-diphenylethylene monomer, 1,2-diphenylethylene monomer, and mixtures thereof. In addition to the monomers and polymers noted, in embodiments the B blocks also comprises a hydrogenated copolymer of such monomer (s) with a conjugated diene selected from 1,3-butadiene, isoprene and mixtures thereof, having a vinyl content of between 20 and 80 mol percent. These copolymers with hydrogenated dienes can be any of random copolymers, tapered copolymers, block copolymers or controlled distribution copolymers. The block B is selectively sulfonated, containing from about 10 to about 100 mol % sulfonic acid or sulfonate salt functional groups based on the number of monomer units. In embodiments, the degree of sulfonation in the B block ranges from 10 to 95 mol %, or 15-80 mol %, or 20-70 mol %, or 25-60 mol %, or >20 mol %, or >50 mol %.

The D block comprises a hydrogenated polymer or copolymer of a conjugated diene selected from isoprene, 1,3-butadiene and mixtures thereof. In other examples, the D block is any of an acrylate, a silicone polymer, or a polymer of isobutylene with a number average molecular weight of >1000, or >2000, or >4000, or >6000.

The coupling agent X is selected from coupling agents known in the art, including polyalkenyl coupling agents, dihaloalkanes, silicon halides, siloxanes, multifunctional epoxides, silica compounds, esters of monohydric alcohols with carboxylic acids, (e.g., methylbenzoate and dimethyl adipate) and epoxidized oils.

The properties of the sulfonated polymer can be varied and controlled by varying the amount of sulfonation, the degree of neutralization of the sulfonic acid groups to the sulfonated salts, as well as controlling the location of the sulfonated group(s). In embodiments, the sulfonated polymer is selectively sulfonated for desired water dispersity properties or mechanical properties, e.g., having the sulfonic acid functional groups attached to the inner blocks or middle blocks, or in the outer blocks of a copolymer, as in U.S. Pat. No. 8,084,546, incorporated by reference. If the outer (hard) blocks are sulfonated, upon exposure to water, hydration of the hard domains may result in plasticization of those domains and softening, allowing dispersion or solubility.

The sulfonated copolymer in embodiments is as disclosed in Patent Publication Nos. U.S. Pat. Nos. 9,861,941, 8,263,713, 8,445,631, 8,012,539, 8,377,514, 8,377,515, 7,737,224, 8,383,735, 7,919,565, 8,003,733, 8,058,353, 7,981,970, 8,329,827, 8,084,546, 8,383,735, 10,202,494, and 10,228,168, incorporated herein by reference.

In embodiments, the sulfonated block copolymer has a general configuration A-B-(B-A)₁₋₅, wherein each A is a non-elastomeric sulfonated monovinyl arene polymer block and each B is a substantially saturated elastomeric alpha-olefin polymer block, said block copolymer being sulfonated to an extent sufficient to provide at least 1% by weight of sulfur in the total polymer and up to one sulfonated constituent for each monovinyl arene unit. The sulfonated polymer can be used in the form of their acid, alkali metal salt, ammonium salt or amine salt.

In embodiments, the sulfonated block copolymer is a sulfonated multiblock (two or more blocks) copolymer of polystyrene and butadiene or isoprene, sulfonated in the butadiene or isoprene segment or segments. In embodiments, the sulfonated block copolymer is a sulfonated t-butylstyrene/isoprene random copolymer with C═C sites in their backbone. In embodiments, the sulfonated polymer is a sulfonated SBR (styrene butadiene rubber) as disclosed in U.S. Pat. No. 6,110,616 incorporated by reference. In embodiments, the sulfonated polymer is a water dispersible BAB triblock, with B being a hydrophobic block such as alkyl or (if it is sulfonated, it becomes hydrophilic) poly(t-butyl styrene) and A being a hydrophilic block such as sulfonated poly(vinyl toluene) as disclosed in U.S. Pat. No. 4,505,827 incorporated by reference. In embodiments, the sulfonated block copolymer is a functionalized, selectively hydrogenated block copolymer having at least one alkenyl arene polymer block A and at least one substantially completely, hydrogenated conjugated diene polymer block B, with substantially all of the sulfonic functional groups grafted to alkenyl arene polymer block A (as disclosed in U.S. Pat. No. 5,516,831, incorporated by reference). In embodiments, the sulfonated polymer is a water-soluble polymer, a sulfonated diblock polymer of t-butyl styrene/styrene, or a sulfonated triblock polymer of t-butyl styrene-styrene-t-butyl styrene as disclosed in U.S. Pat. No. 4,492,785 incorporated by reference. In embodiments, the sulfonated block copolymer is a partially hydrogenated block copolymer.

In embodiments, the sulfonated polymer is a midblock-sulfonated triblock copolymer, or a midblock-sulfonated pentablock copolymer or, e.g., a poly(p-tert-butylstyrene-b-styrenesulfonate-b-p-tert-butyl styrene), or a poly[tert-butylstyrene-b-(ethylene-alt-propylene)-b-(styrenesulfonate)-b-(ethylene-alt-propylene)-b-tert-butylstyrene.

In embodiments, the sulfonated polymer is a sulfonated block copolymer, e.g., a midblock-sulfonated pentablock copolymer, containing >40 mol % sulfonic acid or sulfonate salt functional groups based on the number of monomer units.

In embodiments, the sulfonated polymer contains >15 mol %, or >25 mol %, or >30 mol %, or >40 mol %, or >60 mol % sulfonic acid or sulfonate salt functional groups based on the number of monomer units in the polymer that are available or susceptible for sulfonation, e.g., the styrene monomers.

The sulfonated polymer for use as a barrier layer or proton electrode membrane is a selectively permeable membrane having excellent moisture vapor transport rates (MVTR) characteristics, and excellent ionic exchange capacity (IEC). In embodiments, the sulfonated polymer is characterized as having MVTR of MVTR of >100, or >500, or >1,000 g/m² per day. ASTM E-96B and ASTM F1249 specify standard methods for measuring MVTR, with common test conditions being 50° C. temperature and 10% relative humidity. In embodiments, the sulfonated polymer is characterized as having air permeability to be less than say less than 5 g/m² per day.

In embodiments, the sulfonated polymer is cross-linked, or the sulfonated polymer composition further comprises a non-sulfonated polymer to improve wet state properties as disclosed in U.S. patent application Ser. No. 18/161,977 with a filing date of Jan. 31, 2023, incorporated herein by reference.

In embodiments, the sulfonated polymer is characterized as having favorable ion-exchange capacity and proton conductivity, and glass transition temperature, providing both flexibility and material strength, and good stability and swelling properties even when hydrated.

Membrane Electrode Assembly (“MEA”): The electrochemical cell assembly further comprises a MEA. The MEA comprises an ion exchange membrane, and a pair of electrocatalyst layers as a pair of electrodes (anode and cathode), arranged on opposite sides of the ion exchange membrane. One of the electrocatalyst layer acts as an anode (first electrode layer), while the other electrocatalyst layer acts as a cathode (second electrode layer). In embodiments, the anode and cathode are coated with a catalyst layer (thus the term “electrocatalyst”). In embodiments, the anode is coated with a catalyst, including but not limited to catalysts in which a metal or alloy such as platinum, ruthenium, palladium, nickel, iron, molybdenum, tungsten, tin, iridium, or rhodium is supported on carbon black. In embodiments, the cathode is coated with a catalyst, including but not limited to catalysts in which platinum, titanium or the like is supported on carbon black, carbon nano tube or carbon nano horn or the like. In embodiments, the anode, the cathode, or both are coated with a catalyst and a proton electrode membrane, e.g., sulfonated polymer.

In embodiments, the ion exchange membrane is a proton exchange membrane (“PEM”) that is conductive to cations, while being non-conductive to anions. In embodiments, the ion exchange membrane is an anion exchange membrane (“AEM”) that is conductive to anions while being non-conductive to cations. In embodiments, the ion exchange membrane is permeable to a first fluid or ion and is impermeable to a second fluid or ion.

In embodiments, the MEA further comprises GDL between the ion exchange membrane and the electrocatalysts layers. The GDL, in embodiments, also function as an electrocatalyst layer (or as a gas diffusion electrode), in which the GDL are coated with a catalyst layer on the side facing the ion conductive layer. In embodiments, the GDL is additionally coated with a PEM material, e.g., sulfonated polymer.

In embodiments, the electrochemical cell assembly is configured such that the MEA is passive, i.e., without the need for a voltage application system.

Voltage can be applied to the MEA with the use of a power source (“voltage application unit”), such as a battery, alternating current, etc. In embodiments, voltage is applied to the MEA when there is a lower concentration of a permeable fluid in the feed as opposed to the permeate (fluid on the opposite side of the barrier layer), e.g., flux may occur passively with no need to energize the assembly. As an example, if the MEA is designed to reduce moisture concentration from an enclosure, it would be energized in occasions where the moisture content in the enclosure is lower than the moisture concentration outside of the enclosure.

In embodiments, the electrochemical cell comprises more than one MEA, with the MEAs being connected in series, such that the outlet from one MEA is fed into the second MEA. In such a configuration, the constituents in the outlet of the preceding MEA can further broken down, or combined with another feed stream, for further separation/processing in the subsequent MEAs. The subsequent MEA can be provided with a barrier layer made of the same or different material from the first barrier layer with selective permeability depending on the feed stream to be processed.

MEA with Proton Exchange Membrane as Ion Exchange Membrane: In embodiments, the MEA has a proton exchange membrane (“PEM”) as the ionic exchange membrane between a first electrocatalyst layer (anode) and a second electrocatalyst layer (cathode). The barrier layer can be adjacent to the first electrocatalyst layer or second electrocatalyst layer.

In MEAs comprising PEMs as the ion exchange member, fluid is separated or broken down at the anode, e.g., water is converted into constituents such as hydrogen ions and oxygen gas. The positively charged ions, e.g., hydrogen ions move through the ion exchange membrane to the cathode and are converted into hydrogen ions H² or H⁺, which escape to the air, or can be trapped and stored for later use. In embodiments where the barrier layer is adjacent to the first electrocatalyst layer (anode), the oxygen generated at the anode accumulates in the gap between the barrier layer and the anode. The oxygen can either be released to the air or can be trapped and stored for later use as the barrier layer is impermeable to oxygen. In embodiments where a barrier layer is adjacent to the second electrocatalyst layer (cathode), the hydrogen ions accumulate in the gap between the cathode and the second barrier layer to enable capture or release of the cations.

In embodiments, when the fluid to remove from an enclosure is humidity/moisture, the moisture received from the enclosure via the inlet conduit passes through the barrier layer to the first electrochemical cell (anode) and is converted into hydrogen ions and the oxygen gas. The barrier layer, being impermeable to the oxygen gas, prevents the passage of the of the oxygen gas back to the enclosure. The oxygen gas generated at the anode is released to the air or collected at the space/gap between the MEA and the barrier layer and diverted for later use. Further, the hydrogen ions, generated at the anode, move to the cathode through the ion exchange membrane under the influence of electric field between the anode and the cathode. At the cathode the hydrogen ions get converted into hydrogen gas. The generated hydrogen gas moves to the inside of the enclosure via the outlet conduit.

PEM Materials: The PEM may comprise, consist essentially of, or consist of the sulfonated polymer as described herein. In embodiments, the PEM comprises perfluorosulfonic acid-based, fluorine ion-exchange resins; and more specifically, perfluorocarbon sulfonic acid-based polymers (PFS polymers) obtained by substituting the C—H bonds of hydrocarbon-based ion-exchange membranes with fluorine, and the like. The inclusion of the highly electronegative fluorine atom enables a very high chemical stability, a high degree of dissociation of the sulfonic group, and a high ionic conductivity.

MEA with Anion Exchange Membrane as Ion Exchange Membrane: In embodiments, the MEA has an anion exchange membrane (“AEM”) as the ion exchange membrane between a first electrocatalyst layer (anode) and a second electrocatalyst layer (cathode). The barrier layer can be adjacent to the first electrode layer or second electrode layer.

In MEAs comprising AEMs as the ion exchange member, a fluid, e.g., water, is reduced to ions, e.g., hydroxyl ions and hydrogen. The negatively charged ions, e.g., hydroxyl ions, move through the ion exchange membrane from the second electrocatalyst layer (cathode) to the first electrocatalyst layer (anode), where the ions can be captured and stored for later use, released, or converted into second fluid, e.g., water, after being combined with other ions. In embodiments where the barrier layer is adjacent to the first electrocatalyst layer (anode), the negatively charged ions accumulate in the gap between the anode and the barrier layer to enable capture or release of the anions. In embodiments where the barrier layer is adjacent to the second electrocatalyst layer (cathode), the positively charged ions, e.g., hydrogen, can be collected from gap between the barrier layer and the cathode, and released to the air or captured for subsequent use.

In embodiments, when the fluid to be removed from an enclosure is humidity/moisture, the barrier layer is impermeable to hydrogen gas which maintains the hydrogen content inside the enclosure without increasing. The second electrocatalyst layer arranged adjacent to the barrier layer defines the cathode of the MEA, while the first electrocatalyst is defined as the anode. At the second electrocatalyst layer, the water received from the enclosure is converted in hydroxyl ions and hydrogen gas. The hydroxyl ions move through the ion exchange membrane to the first electrocatalyst layer and are converted into water and oxygen gas, or hydrogen peroxide, or sodium hydroxide, or other oxidized or reduced fluids. The hydrogen gas generated at the second electrocatalyst layer (cathode) is accumulated inside the gap between the cathode and the barrier layer that can be either released to the air or can be stored for a later use.

AEM Materials: The AEM may have anion conductivity by including, for example, quaternary ammonium polysulfone (QAPA), benzyl trimethylammonium cation, and the like as an electrolyte. In embodiments, the AEM electrolytes include hydrocarbon-based resins, e.g., styrene block copolymers such as polystyrene-polybutadiene-polystyrene (SBS), polystyrene-poly(ethylene-ran-butylene)-polystyrene (SEBS), and functionalized block copolymers. In embodiments, the AEM includes fluorine-based resins.

Hybrid MEA: A membrane electrode assembly may be implemented as a hybrid type MEA by including a PEM and an AEM. In embodiments, the AEM, may contact the PEM, while partially or fully overlapping each other. In embodiments, the PEM and the AEM comprise an adhesive such as an epoxy-based adhesive.

Method for Using Electrochemical Cell Assembly: In embodiments, a fluid separation assembly comprises an enclosure and an electrochemical cell assembly. In embodiments, the electrochemical cell assembly is located outside the enclosure such that an outside surface of the barrier layer is arranged in fluid communication with the enclosure (via a tube connected to the enclosure, or an opening on the wall of the enclosure), while the gap is arranged outside the enclosure between the barrier layer and the first electrocatalyst layer of the MEA.

In embodiments, the electrochemical cell assembly is in fluid communication to the enclosure via an intake conduit and an outlet conduit. The intake conduit extends from the enclosure to the electrochemical cell to allow a flow of fluids from the inside of the enclosure to an outside surface of the barrier layer, while the outlet conduit facilitates a flow of constituents from the MEA to the air, to a reservoir be collected, or back to the enclosure. In embodiments, multiple barriers layers can be used to facilitate filtering/extraction of selected fluids or constituents. The outlet conduit connects the cathode to the enclosure, the air or additional reservoir for collection.

In embodiments, the electrochemical cell assembly may include a pump or fan to enable a flow of fluid from the enclosure to the electrochemical cell assembly and a flow of constituents from the electrochemical cell assembly to the enclosure, a reservoir, or to the air.

Applications: The MEA can be used in hydrolysis including humidification or dehumidification, electrochemical conversion and synthesis, CO₂ capture, gas sweetening, electrolyzer, fluid separation, fuel cell, e.g., hydrogen, oxygen, proton-electron, methanol, etc. The MEA can be used to separate fluids, molecules, and/or ions, and in embodiments, enable capturing fluids, molecules, and/or ions for later use. In embodiments, the MEA can be used to remove a fluid, e.g., H₂O from an enclosure, without increasing oxygen content inside the enclosure. In embodiments, the barrier layer can be used to for oxygen control, e.g., reduce oxygen by humidifying or increase oxygen by hydrolyzing water and capturing oxygen in the process.

In embodiments, for selective removal and subsequent capture of CO₂, the barrier layer comprises a sulfonated pentablock polymer from Kraton Corporation, having a formula of poly[tert-butylstyrene-b-(ethylene-altpropylene)-b-(styrene-co-styrenesulfonate)-b-(ethylene-alt-propylene)-b-tert-butylstyrene. The sulfonated pentablock polymer can be modified for an ultrahigh NH₃ permeability exceeding 5000 Barrers, a high NH₃/N₂ permeability ratio of ≈1860, a moderate CO₂ permeability of ≈100 Barrers, and a CO₂/N₂ permeability ratio of ≈56, lending to the use of the barrier layer in systems for selective removal, and subsequent capture of CO₂ from mixed gas streams to reduce the environmental contamination.

In embodiments, the MEA can be used for a reaction of sodium chloride into sodium hydroxide, when the MEA comprises a PEM as the ion exchange membrane, via the reduction of water into hydrogen and association of the resulting hydroxide with sodium. In such embodiment, the function of the barrier layer is to enable capture of hydrogen gas (on the anode side of the MEA) as the barrier layer would be impermeable to sodium hydroxide.

In embodiments for applications when the ion exchange membrane is an AEM, the MEA is paired with a second MEA. This configuration enables the generation and capture of hydrogen peroxide by the oxidation reaction of hydroxide ions.

Examples: The following illustrative examples are intended to be non-limiting.

The components used in the examples include:

Sulfonated Polymer SPBC: Sulfonated pentablock copolymers of the structure poly[tert-butylstyrene-b-(ethylene-alt-propylene)-b-(styrene-co-styrene-isulfonate)-b-(ethylene-alt-propylene)-tert-butylstyrene] (tBS-EP-sPS-EP-tBS) having properties in Table 1 are used for some of the examples.

TABLE 1

| Polymer | IEC (meg/g) | Degree of sulfonation (mol %) | MW (kg/mol) |
|---|---|---|---|
| SPBC | 2.0 | 52 | 78 |

Example 1: Film samples of the sulfonated polymers were cast out of 1:1 mixture of toluene and 1-propanol. The sulfonated polymers film samples were subjected to MOCON gas transmission rate tests to measure transmission rates of N₂, CO, O₂ H₂, CO₂ and H₂O through the film samples, using single gas permeability.

TABLE 2
Gas Transmission Rates of film samples

| | N₂ | CO | O₂ | H₂ | CO₂ | H₂O |
|---|---|---|---|---|---|---|
| MOCON gas | 1.88 | 3.13 | 8.13 | 47.5 | 55.6 | 13,200* |
| transmission rate | | | | | | |
| (1,000 cc/m₂ · day) | | | | | | |
| Permeability vs | N/A | 1.7:1 | 4.3:1 | 25.3:1 | 29.7:1 | 1,702:1* |
| N₂ | | | | | | |

*H₂O permeability for reference, measured via MVTR testing, using 50° C. and 10% RH environmental chamber conditions.

Example 2: The sulfonated polymer film sample along with a non-woven spacer were added to the anode side of an MEA (16 cm² electrolyzer) as a selectively permeable barrier layer. The MEA was assembled inside a rebuildable fuel cell kit (H-TEC Education, product code 1071042). The MEA was affixed via an opening on the side of a container (2.3 L enclosure) using a circulating air pump (Yanmis 12V, 5 L/min pump kit, code 40151500) passing air from the enclosure over the surface of the selectively permeable sulfonated polymer barrier layer, through the MEA, and returning air to the enclosure. In this process, enclosure air permeates through the sulfonated polymer barrier layer, positioning moisture between the barrier layer and the electrocatalyst layer. As hydrolysis dissociates water into hydrogen and oxygen, hydrogen passes through the MEA while oxygen remains trapped in the barrier layer spacer, venting perpendicularly to the hydrogen flow direction. The goal of this assembly was to dehumidify the container without increasing the oxygen concentration of the container in the process. A MEA without a selectively permeable barrier layer was also tested in the same matter. The results are in Table 3 and Table 4, respectively.

TABLE 3
Performance of MEA with sulfonated polymer film
as selective permeable barrier layer.

| | Time (minutes) | | | | | | |
|---|---|---|---|---|---|---|---|
| | 0 | 5 | 10 | 15 | 20 | 25 | 30 |
| Chamber | 58.5 | 54.0 | 46.0 | 39.0 | 33.5 | 30.0 | 28.0 |
| relative | | | | | | | |
| humidity, % | | | | | | | |
| Chamber | 20.9 | 20.9 | 20.8 | 20.9 | 20.9 | 20.9 | 20.8 |
| oxygen | | | | | | | |
| concentration, | | | | | | | |
| % | | | | | | | |

TABLE 4
Performance of MEA without selective permeable
barrier layer

| | Time (minutes) | | | | | | |
|---|---|---|---|---|---|---|---|
| | 0 | 5 | 10 | 15 | 20 | 25 | 30 |
| Chamber | 59.4 | 39.6 | 29.6 | 24 | 20.5 | 18.6 | 17.3 |
| relative | | | | | | | |
| humidity, % | | | | | | | |
| Chamber | 20.9 | 21.6 | 21.9 | 22.2 | 22.5 | 22.7 | 23.0 |
| oxygen | | | | | | | |
| concentration, | | | | | | | |
| % | | | | | | | |

Reference will be made to the figures, showing various embodiments of the membrane electrode assembly.

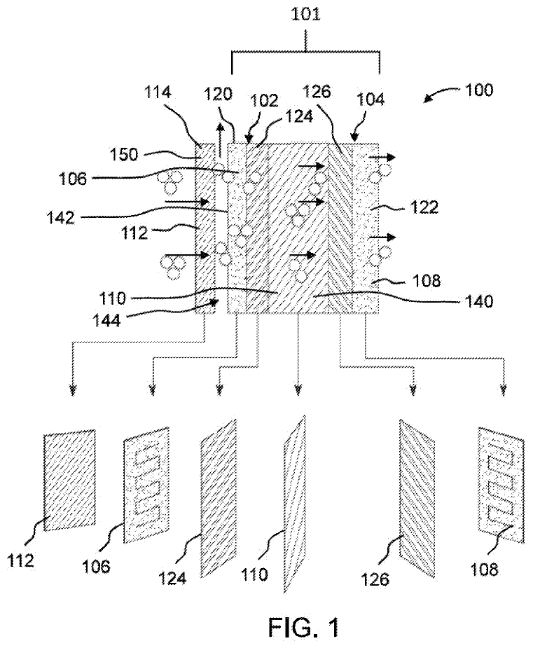

FIG. 1 illustrates an electrochemical cell assembly 100 according to embodiments of the disclosure. The electrochemical cell assembly 100 includes a membrane electrode assembly (MEA) 101 containing a pair of electrocatalyst layers 102, 104 defining a pair of electrodes 106, 108 connected to electric power source, for example, a battery, an ion exchange membrane 110 arranged between the pair of electrocatalyst layers 102, 104, and a barrier layer 112 arranged as an outer layer 114 of the MEA 101. As shown, the pair of electrocatalyst layers, for example, a first electrocatalyst layer 102 and a second electrocatalyst layer 104, are arranged spaced apart and facing each other, and respectively includes a first electrode layer 106 and a second electrode layer 108 of the MEA 101. In the illustrated embodiment of FIG. 1, the first electrode layer 106 is defined an anode 120 of the MEA 100, while the second electrode layer 108 is defines a cathode 122 of the MEA 101 by applying the suitable electric potential across the first electrode layer 106 and the second electrode layer 108. Further, the first electrocatalyst layer 102 may optionally include a first GDL 124 arranged between the ion exchange membrane 110 and the first electrode layer 106, while the second electrocatalyst layer 104 may optionally include a second GDL 126 arranged between the ion exchange membrane 110 and the second electrode layer 108. Although, the GDL 124, 126 and the electrode layers 106, 108 are shown and contemplated as separate layers, it may be appreciated that the GDL 124, 126 may be integrated with the respective electrode layers 106, 108.

As seen from the FIG. 1, a first outer surface of the ion exchange membrane 110 contacts an inner surface of the first GDL 124 (i.e., inner surface of the first electrocatalyst layer 102), while a second outer surface of the ion exchange membrane 110 contacts an inner surface of the second GDL 126 (i.e., an inner surface of the second electrocatalyst layer 104). In the illustrated embodiment, the ion exchange membrane 110 is a PEM 140 that facilitates a flow of positive ions, e.g., hydrogen ions, while blocks the flow of negative ions, e.g., oxygen. The hydrogen ions flow from the anode 120 to the cathode 122 under the influence of an electric field generated between the anode 120 and the cathode 122. At the anode 120, the water is converted into the hydrogen ions and oxygen gas, while at the cathode the hydrogen ions received from the anode is converted into the hydrogen gas.

Additionally, the barrier layer 112 (i.e., a first barrier layer) of the electrochemical cell assembly 100 is arranged at a distance from an outer surface 142 of the first electrocatalyst layer 102 of the MEA 101. Accordingly, a gap 144 is defined between the barrier layer 112 and an outer surface 142 of the first electrocatalyst layer 102 (i.e., the anode 120). In embodiments, the barrier layer 112 is supported on a spacer or a frame that may be electrically non-conducting. In some embodiments, the barrier layer 112 is supported on a nonwoven fabric. The spacer may contact the outer surface 142 of the first electrocatalyst layer 102 to maintain the gap 144 between the barrier layer 112 and the anode 120. In the illustrated embodiment, the barrier layer 112 is sulfonated polymer 150, that is permeable to the first fluid, e.g., water and is relatively impermeable to the second fluid, e.g., oxygen gas. Accordingly, the electrochemical cell assembly 100 can be used to control the movement of fluids, molecules, and/or ions into and out of the MEA 101 for separation or capture for subsequent use. In embodiments, the electrochemical cell assembly 100 can be used to control the amount of a fluid, e.g., moisture, inside an enclosure without increasing corresponding ion content, e.g., oxygen gas, inside the original space, or enclosure and/or capture corresponding ion, e.g., oxygen from the moisture, as explained later. In embodiments, as the moisture that flows to the anode 120 from the enclosure through the barrier layer 112, water is converted into the hydrogen ions and oxygen gas at the anode 120. In embodiments, the generated oxygen gas remains inside the gap 144, which is either discharged to the air or collected and stored for later use, while the hydrogen ions move to the cathode 122 through the PEM 140.

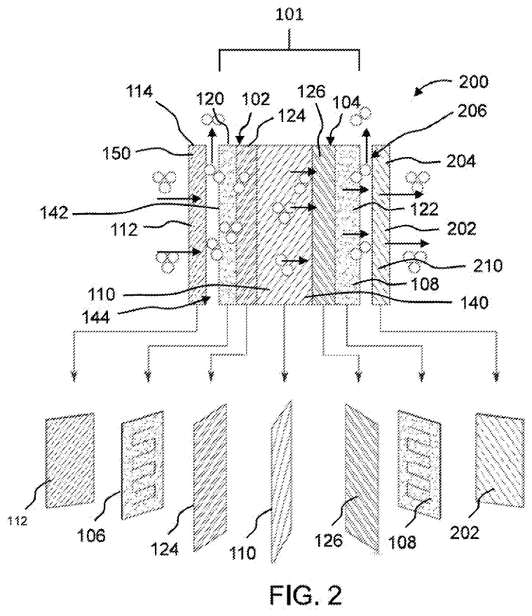

Referring to FIG. 2, an electrochemical cell assembly 200 which is suitable to capture both fluid and its constituents in the gap between the barrier layers and the outside surfaces of a MEA 101 is shown according to an alternative embodiment of the disclosure. The electrochemical cell assembly 200 is similar to the electrochemical cell assembly 100 except that the electrochemical cell assembly 100 includes a second barrier layer 202 as an outer layer 204 that is arranged facing the cathode 122 (i.e., the second electrocatalyst layer 104) of the MEA 101 and at a distance from the cathode 122 defining a second gap 206 therebetween. The second barrier layer 202 can be the sulfonated polymer or another selectively permeable barrier layer 210 which is permeable to a first fluid and is relatively impermeable to second fluid. As with the first barrier layer 112, the second barrier layer 202 may be supported on a spacer or a frame. Due to the presence of the second barrier layer 202, the fluid and/or its constituents in generated at the cathode 122 moves/accumulates inside the second gap 204 between the second electrocatalyst layer 104 and the second barrier layer 202. The fluid and/or and its constituents in present inside the second gap 204 may be stored for a later use.

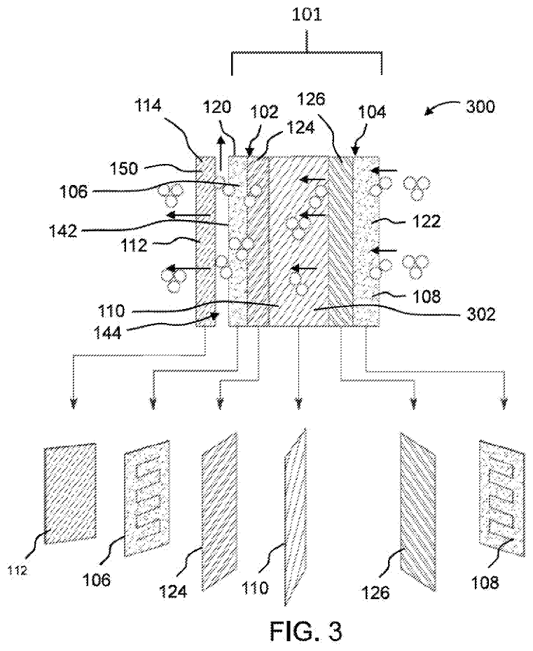

Referring to FIG. 3, an electrochemical cell assembly 300 according to a yet another embodiment is shown. The electrochemical cell assembly 300 is similar to the electrochemical cell assembly 100 except that the ion exchange membrane 110 of the MEA 101 is an AEM 302 instead of the PEM. The AEM 302 is permeable to negative ions, e.g., hydroxyl ions and impermeable to positive ions, e.g., hydrogen gas/ions. In such a case, the first fluid, e.g., water, that contacts with the cathode 122 is converted into its corresponding constituents, e.g., hydroxyl ions and hydrogen gas under the suitable electric potential. The negatively charged ions, e.g., hydroxyl ions, move to the anode 120 through the AEM 302 under the influence of the electric field generated between the anode 120 and the cathode 122. The negatively charged ions, can be converted into another fluid, e.g., water, which can move through the barrier layer 112 to the air, an enclosure to increase the content inside the enclosure, or capture for subsequent use. Other ions or gases generated at the anode can accumulate in the gap 144 as the barrier layer 112 is a PEM 150 for subsequent capture or storage for later use.

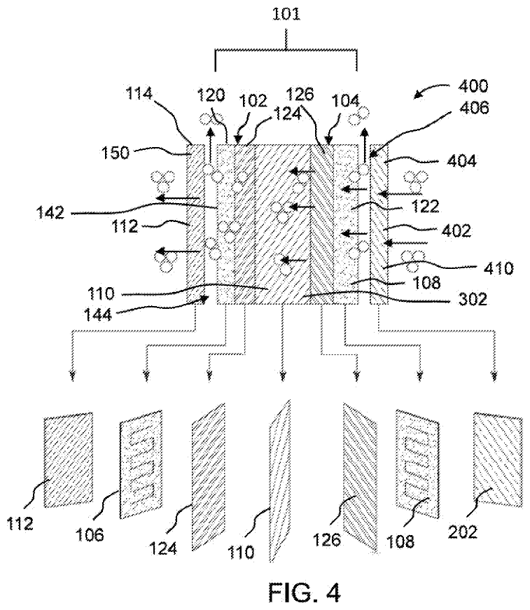

Referring to FIG. 4, an electrochemical cell assembly 400 according to embodiments is shown. The electrochemical cell assembly 400 is similar to the electrochemical cell assembly 300 except that the MEA 101 includes a second barrier layer 402 as an outer layer 404 that is arranged facing the cathode 122 (i.e., the second electrocatalyst layer 104) and at a distance from the cathode 122 defining a second gap 406 therebetween. The second barrier layer 402 can be the sulfonated polymer or another selectively permeable barrier layer 410 which is permeable to a fluid, e.g., water and is relatively impermeable to its constituents, e.g., hydrogen gas, or second fluid. As with the first barrier layer 110, the second barrier layer 402 may be supported on a spacer or a frame. Due to the presence of the second barrier layer 402, the second fluid, e.g., hydrogen gas, generated at the cathode 122 moves/accumulates inside the second gap 406 between the second electrocatalyst layer 104 and the second barrier layer 402. The second fluid, e.g., hydrogen gas, present inside the second gap 406 may be stored for a later use.

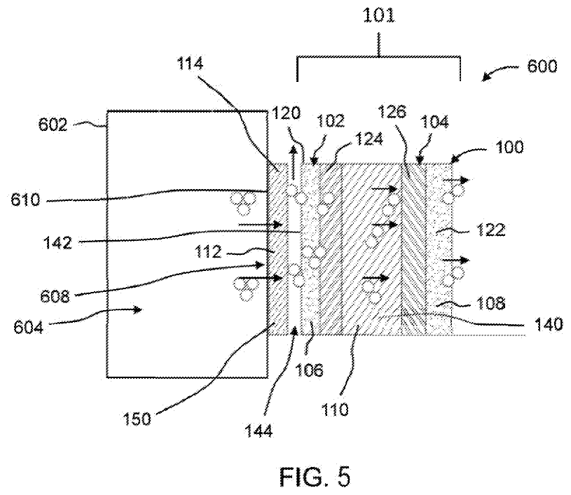

Referring to FIG. 5, an enclosure assembly 600 having the electrochemical cell assembly 100 is disclosed. As shown, the enclosure assembly 600 includes an enclosure 602 defining a chamber 604 to receive at least one article for storage purpose, and an opening 608 providing access to the chamber 604. Further, the electrochemical cell assembly 100 is mounted/attached to the enclosure 602 such that the barrier layer 112 (i.e., the PEM 150) is arranged covering the opening 608 such that a first surface 610 of the barrier layer 112 is arranged facing an interior of the chamber 604 of the enclosure 602, while a second surface arranged opposite to the first surface 610 is arranged facing an exterior of the enclosure 602. Accordingly, the fluid present inside the enclosure 602 can only move outside the enclosure 602 through the barrier layer 112. The electrochemical cell assembly 100 is arranged or mounted on the enclosure 602 such that the gap 144 is arranged outside the enclosure 602. Accordingly, the negative ions (constituents) generated at the anode 120 of the MEA 101 remain in the gap 144 as the barrier layer 112 is impermeable to said negative ions. The negative ion/gas, e.g., oxygen gas, present inside the gap 144 may be either discharged to the air through one or more openings defined along the edges of the MEA 101 or can be captured for use. In this manner, the electrochemical cell assembly 100 enables a reduction of a fluid, e.g., moisture, inside the enclosure 602 without increasing its constituents, e.g., oxygen content inside the enclosure 602.

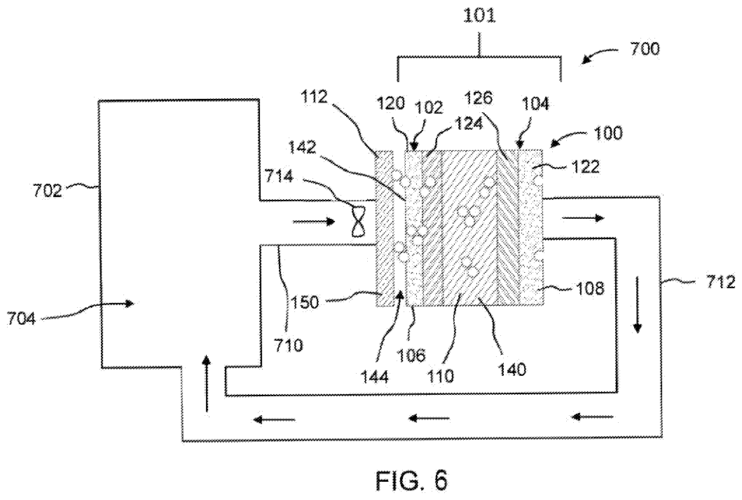

Referring to FIG. 6, an enclosure assembly 700 having the electrochemical cell assembly 100 is disclosed. The enclosure assembly 700 includes an enclosure 702 defining a chamber 704 for storing one or more components/articles and the electrochemical cell assembly 100 is fluidly connected with the enclosure 702 via an inlet conduit 710 and an outlet conduit 712. Further, the enclosure assembly 700 may include a fan 714 arranged at an outlet of the intake conduit 710 to enable a flow of air (i.e., inlet air) containing the fluid, e.g., moisture, from the chamber 704 to the MEA 100 and a flow of air (i.e., outlet air) exiting the electrochemical cell assembly 100 to the chamber 704 via the outlet conduit 712. Although the fan 714 is shown to be arranged at the outlet of the inlet conduit 710, it may be appreciated that the fan 714 be arranged anywhere along the inlet conduit 710. Also, the fan 714 may be installed at an inlet of the outlet conduit 712, an outlet of the outlet conduit 712, or any other location along a length of the outlet conduit 712. The fluid, e.g., moisture, from the chamber 704 flows through the inlet conduit 710 and enters the gap 144 of the electrochemical cell assembly through the barrier layer 112 (i.e., the sulfonated polymer 150) as the barrier layer 112 is permeable to the fluid, e.g., water. Upon passing the barrier layer 112, the fluid, e.g., water, contacts the anode 120 of the MEA 101 at which the fluid is converted into its constituents, e.g., hydrogen ions and the oxygen gas. As both the barrier layer 112 and the ion exchange membrane 110 (i.e., the PEM 140) are relatively impermeable to the negative charged constituents, e.g., oxygen gas, the negative charged constituents, e.g., oxygen gas remains inside the gap 144, while the positive charged constituents, e.g., hydrogen ions, pass through the PEM 150 and reach the cathode 122 under the influence of the electric field applied between the anode 120 and the cathode 122 of the MEA 101. At the cathode 122, the positive charged constituent(s), e.g., hydrogen gas, is produced, which moves to the chamber 704 through the outlet conduit 712. The negative charged constituent(s), e.g., oxygen gas, present inside the gap 144 of the electrochemical cell assembly 100 is discharged to the air through one or more discharge openings of the electrochemical cell assembly 100 defined along the edges of the electrochemical cell assembly 100. In this manner, the electrochemical cell assembly 100 enables a reduction in the fluid, e.g., moisture content inside the enclosure 702 without increasing the constituents, e.g., oxygen, content inside the enclosure 702.

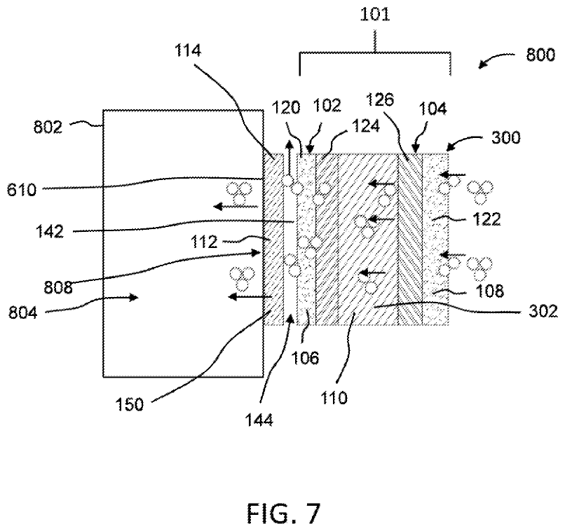

Referring to FIG. 7, an enclosure assembly 800 having the electrochemical cell assembly 300 is disclosed. The electrochemical cell assembly 300 includes the ion exchange membrane 110 as the AEM 302. As shown, the enclosure assembly 800 includes an enclosure 802 defining a chamber 804 to receive at least one article for storage purpose, and an opening 808 providing access to the chamber 804. Further, electrochemical cell assembly 300 is mounted/attached to the enclosure 802 such that the barrier layer 112 which is sulfonated polymer 150 is arranged covering the opening 808 such that the first surface 610 of the barrier layer 112 is arranged facing the chamber 804 of the enclosure 802. The electrochemical cell assembly 300 is arranged or mounted on the enclosure 802 such that the gap 144 is arranged outside the enclosure 802. In embodiments, the negative constituents, e.g., hydroxyl ions, generated at the anode 120 remains inside the gap 144 as the barrier layer 112 is impermeable to negative constituents, e.g., oxygen gas, while a fluid, e.g., water, generated at the anode enters the chamber 804 through the barrier layer 112 and the opening 808. The negative constituents present inside the gap 144 may be either discharged to the air through one or more openings defined along the edges of the electrochemical cell assembly 300 or can be captured for use. In embodiments, the electrochemical cell assembly 300 enables increasing the moisture content (i.e., humidity) inside the enclosure 802 without increasing the oxygen content inside the enclosure 802.

In embodiments, the enclosure 600 or 700 may be a storage box for safely storing one or more articles. For example, the enclosure 600 or 700, may be a food storage box adapted to store food. The electrochemical cell assembly 100, 200, 300, or 400 containing the MEA 101 can be used to electrochemically oxidize other compounds, e.g., carbon dioxide, methanol, ethanol, formaldehyde, formic acid, etc., and electrochemically synthesize compounds, e.g., ammonia, methane, etc. In embodiments, the electrochemical cell assembly 100, 200, or 400 containing the MEA 101, removes the moisture without increasing the oxygen content, facilitates in increasing the shelf life of the food stored inside the enclosure. In some embodiments, the enclosure 600 and 700 may be an antique article container with electrochemical cell assembly 100 facilitating a preservation of the antique article. In this manner, the electrochemical cell assembly 100, 200, 300, or 400 can be utilized for controlling humidity, controlling oxygen content inside an enclosure, controlling hydrogen content inside an enclosure, capturing oxygen gas, and capturing hydrogen gas, etc. The electrochemical cell assembly 100, 200, or 300 can be used for controlling humidity and oxygen content, chemical processing, musical instruments, tobacco/cannabis storage, or as a refrigerator drawer.

As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items.

Unless otherwise specified, all technical and scientific terms used herein have the same meanings as commonly understood by one of skill in the art to which the disclosed disclosure belongs. the recitation of a genus of elements, materials or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. An electrochemical cell assembly comprising:
a membrane electrode assembly to break apart a fluid containing at least a first component and a second component to at least two constituents, a first constituent and a second constituent, the membrane electrode assembly comprises a first electrocatalyst layer, a second electrocatalyst layer, and an ion exchange membrane arranged between the first and second electrocatalyst layers; and
a barrier layer positioned external to the membrane electrode assembly, spaced apart and facing the first or second electrocatalyst layer, the barrier layer comprising a selectively permeable sulfonated polymer membrane, wherein the sulfonated polymer is selected from the group consisting essentially of sulfonated block copolymers, perfluorosulfonic acid polymers, polystyrene sulfonates, sulfonated polyolefins, sulfonated polyimides, sulfonated polyamides, sulfonated polyesters, sulfonated polysulfones, sulfonated polyketones, sulfonated poly(arylene ether), and mixtures thereof, the sulfonated polymer has an ionic exchange capacity (IEC) of at least 0.5 meq/g;
wherein the barrier layer is supported by a spacer layer or a frame for separating the barrier layer from the first or second electrocatalyst layer; and
wherein the barrier layer is selectively permeable to the first and second component and the first and second constituents, the barrier layer having at least one of:
a permeability ratio of the first component to the second component of >5:1,
a permeability ratio of the first constituent and the second constituent of >5:1, and
a permeability ratio of the first or second component to the first or second constituent of >5:1,
thereby restricting the flow of at least one of the components and the constituents.

2. The electrochemical cell assembly of claim 1, wherein the sulfonated polymer membrane has a degree of sulfonation of 10-100 mol %.

3. The electrochemical cell assembly of claim 1, wherein the sulfonated polymer membrane has an ion exchange capacity (IEC) of 0.5 to 2.6 meq/g.

4. The electrochemical cell assembly of claim 1, wherein the sulfonated polymer membrane is a sulfonated styrenic block copolymer obtained by sulfonation of a styrenic block copolymer precursor having a general configuration of: A-B-A, (A-B)ₙ(A), (A-B-A)ₙ, (A-B-A)ₙX, (A-B)ₙX, A-D-B, A-B-D, A-D-B-D-A, A-B-D-B-A, (A-D-B)ₙA, (A-B-D)ₙA (A-D-B)ₙX, (A-B-D)ₙX, (A-D-B-D-A)ₙX, (A-B-D-B-A)ₙX or mixtures thereof, where n is an integer from 2 to 30, and X is a residue of a coupling agent; and wherein:
each block A is derived from polymerized para-substituted styrene monomers selected from the group consisting of para-methylstyrene, para-ethylstyrene, para-n-propylstyrene, para-iso-propylstyrene, para-n-butylstyrene, para-sec-butylstyrene, para-iso-butylstyrene, para-t-butylstyrene, isomers of para-decylstyrene, isomers of para-dodecylstyrene, and mixtures thereof;
each block B is derived from the polymerized vinyl aromatic monomers selected from the group consisting of unsubstituted styrene, ortho-substituted styrene, meta-substituted styrene, alpha-methylstyrene, 1,1-diphenylethylene, 1,2-diphenylethylene, and mixtures thereof; and
each block D is derived from the polymerized conjugated diene monomers selected from the group consisting of isoprene, 1,3-butadiene, 2,3-dimethyl-1,3-butadiene, 1-phenyl-1,3-butadiene, 1,3-pentadiene, 1,3-hexadiene, 3-butyl-1,3-octadiene, farnesene, myrcene, piperylene, cyclohexadiene, and mixtures thereof.

5. The electrochemical cell assembly of claim 1, wherein the ion exchange membrane is a proton exchange membrane.

6. The electrochemical cell assembly of claim 5, wherein the proton exchange membrane is selected from sulfonated polymers, fluorine ion-exchange resins, and mixtures thereof.

7. The electrochemical cell assembly of claim 1, wherein the ion exchange membrane is an anion exchange membrane.

8. The electrochemical cell assembly of claim 7, wherein the anion exchange membrane comprises quaternary ammonium polysulfone, benzyl trimethylammonium cation, electrolytes selected from the group of styrene block copolymers such as polystyrene-polybutadiene-polystyrene, polystyrene-poly(ethylene-ran-butylene)-polystyrene, functionalized block copolymers, fluorine-based resins, and mixtures thereof.

9. The electrochemical cell assembly of claim 1, wherein the electrochemical cell assembly is located outside an enclosure, and wherein the barrier layer is arranged in fluid communication with the enclosure to allow a flow of the fluid from the enclosure to the first electrocatalyst layer and restrict a flow of at least a constituent to the enclosure from the first electrocatalyst layer.

10. The electrochemical cell assembly of claim 1, further comprises a second barrier layer, wherein the barrier layer, the membrane electrode assembly, and the second barrier layer are arranged in series, and wherein the second barrier layer is arranged spaced apart and facing the second electrocatalyst layer.

11. The electrochemical cell assembly of claim 1, wherein the membrane electrode assembly further comprises gas diffusion layers.

12. The electrochemical cell assembly of claim 1, further comprising a voltage application unit configured to apply a voltage to the membrane electrode assembly.

13. The electrochemical cell assembly of claim 1, wherein the electrochemical cell assembly is used in separating and recovering fluid in any of humidification, dehumidification, electrochemical conversion, synthesis, CO₂ capture, gas sweetening, electrolyzer, and fuel cell applications.

14. An electrochemical cell assembly comprising:
a membrane electrode assembly to break apart a fluid containing at least a first component and a second component to at least two constituents, a first constituent and a second constituent, the membrane electrode assembly comprises a first electrocatalyst layer, a second electrocatalyst layer, and an ion exchange membrane arranged between the first and second electrocatalyst layers; and
a first barrier layer and a second barrier layer are external to the membrane electrode assembly, the first barrier layer spaced apart and facing the first electrocatalyst layer of the membrane electrode assembly, and a second barrier layer spaced apart and facing the second electrocatalyst layer of the membrane electrode assembly,
wherein at least one of the first barrier layer and second barrier layer comprises a sulfonated polymer membrane, wherein the sulfonated polymer is selected from the group consisting essentially of sulfonated block copolymers, perfluorosulfonic acid polymers, polystyrene sulfonates, sulfonated polyolefins, sulfonated polyimides, sulfonated polyamides, sulfonated polyesters, sulfonated polysulfones, sulfonated polyketones, sulfonated poly(arylene ether), and mixtures thereof, the sulfonated polymer has an ionic exchange capacity (IEC) of at least 0.5 meq/g;
wherein the barrier layer is supported by a spacer layer or a frame for separating the barrier layer from the first electrocatalyst layer; and
wherein the barrier layer is selectively permeable to the first and second component and the first and second constituents, the barrier layer having at least one of:
a permeability ratio of the first component to the second component of >5:1,
a permeability ratio of the first constituent and the second constituent of >5:1, and
a permeability ratio of the first or second component to the first or second constituent of >5:1,
thereby restricting the flow of at least one of the components and the constituents.

15. The electrochemical cell assembly of claim 14, wherein the sulfonated polymer membrane has a degree of sulfonation of 10-100 mol %.

16. The electrochemical cell assembly of claim 14, wherein the sulfonated polymer membrane is a sulfonated styrenic block copolymer obtained by sulfonation of a styrenic block copolymer precursor having a general configuration of: A-B-A, (A-B)ₙ(A), (A-B-A)ₙ, (A-B-A)ₙX, (A-B)ₙX, A-D-B, A-B-D, A-D-B-D-A, A-B-D-B-A, (A-D-B)ₙA, (A-B-D)ₙA (A-D-B)ₙX, (A-B-D)ₙX, (A-D-B-D-A)ₙX, (A-B-D-B-A)ₙX or mixtures thereof, where n is an integer from 2 to 30, and X is a residue of a coupling agent; and wherein:
each block A is derived from polymerized para-substituted styrene monomers selected from the group consisting of para-methylstyrene, para-ethylstyrene, para-n-propylstyrene, para-iso-propylstyrene, para-n-butylstyrene, para-sec-butylstyrene, para-iso-butylstyrene, para-t-butylstyrene, isomers of para-decylstyrene, isomers of para-dodecylstyrene, and mixtures thereof;
each block B is derived from the polymerized vinyl aromatic monomers selected from the group consisting of unsubstituted styrene, ortho-substituted styrene, meta-substituted styrene, alpha-methylstyrene, 1,1-diphenylethylene, 1,2-diphenylethylene, and mixtures thereof; and
each block D is derived from the polymerized conjugated diene monomers selected from the group consisting of isoprene, 1,3-butadiene, 2,3-dimethyl-1,3-butadiene, 1-phenyl-1,3-butadiene, 1,3-pentadiene, 1,3-hexadiene, 3-butyl-1,3-octadiene, farnesene, myrcene, piperylene, cyclohexadiene, and mixtures thereof.

17. A fluid separation assembly, comprising:
an enclosure; and
an electrochemical cell assembly arranged in fluid communication with the enclosure and adapted to receive or provide a fluid to the enclosure, the electrochemical cell assembly comprising:
a membrane electrode assembly to break apart a fluid containing at least a first component and a second component to at least two constituents, a first constituent and a second constituent, the membrane electrode assembly comprises a first electrocatalyst layer, a second electrocatalyst layer, and an ion exchange membrane arranged between the first and second electrocatalyst layers; and
an barrier layer spaced apart and facing the first electrocatalyst layer of the membrane electrode assembly, the barrier layer comprising a sulfonated polymer membrane, wherein the sulfonated polymer is selected from the group consisting essentially of sulfonated block copolymers, perfluorosulfonic acid polymers, polystyrene sulfonates, sulfonated polyolefins, sulfonated polyimides, sulfonated polyamides, sulfonated polyesters, sulfonated polysulfones, sulfonated polyketones, sulfonated poly(arylene ether), and mixtures thereof, the sulfonated polymer has an ionic exchange capacity (IEC) of at least 0.5 meq/g;
wherein the barrier layer is supported by a spacer layer or a frame for separating the barrier layer from the first electrocatalyst layer; and
wherein the barrier layer is selectively permeable to the first and second component and the first and second constituents, the barrier layer having at least one of:
a permeability ratio of the first component to the second component of >5:1,
a permeability ratio of the first constituent and the second constituent of >5:1, and
a permeability ratio of the first or second component to the first or second constituent of >5:1,
thereby restricting the flow of at least one of the components and the constituents.

18. The fluid separation assembly of claim 17, wherein the sulfonated polymer membrane has a degree of sulfonation of 10-100 mol %.

19. The fluid separation assembly of claim 17, wherein the sulfonated polymer membrane is a sulfonated styrenic block copolymer obtained by sulfonation of a styrenic block copolymer precursor having a general configuration of: A-B-A, (A-B)ₙ(A), (A-B-A)ₙ, (A-B-A)ₙX, (A-B)ₙX, A-D-B, A-B-D, A-D-B-D-A, A-B-D-B-A, (A-D-B)ₙA, (A-B-D)ₙA (A-D-B)ₙX, (A-B-D)ₙX, (A-D-B-D-A)ₙX, (A-B-D-B-A)ₙX or mixtures thereof, where n is an integer from 2 to 30, and X is a residue of a coupling agent; and wherein:
each block A is derived from polymerized para-substituted styrene monomers selected from the group consisting of para-methylstyrene, para-ethylstyrene, para-n-propylstyrene, para-iso-propylstyrene, para-n-butylstyrene, para-sec-butylstyrene, para-iso-butylstyrene, para-t-butylstyrene, isomers of para-decylstyrene, isomers of para-dodecylstyrene, and mixtures thereof;
each block B is derived from the polymerized vinyl aromatic monomers selected from the group consisting of unsubstituted styrene, ortho-substituted styrene, meta-substituted styrene, alpha-methylstyrene, 1,1-diphenylethylene, 1,2-diphenylethylene, and mixtures thereof; and
each block D is derived from the polymerized conjugated diene monomers selected from the group consisting of isoprene, 1,3-butadiene, 2,3-dimethyl-1,3-butadiene, 1-phenyl-1,3-butadiene, 1,3-pentadiene, 1,3-hexadiene, 3-butyl-1,3-octadiene, farnesene, myrcene, piperylene, cyclohexadiene, and mixtures thereof.

20. The fluid separation assembly of claim 17, wherein the fluid separation assembly is a dehumidifier, and for a reduction of relative humidity in the enclosure of at least 10%, and a reduction in oxygen (O₂) content by >5% compared to a fluid separation assembly without having a barrier layer in the electrochemical cell.
